(19) United States
(12) Patent Application Publication
(10) Pub. No.: US 2006/0114486 A1
(43) Pub. Date: Jun. 1, 2006

(54) Print image generating method of print driver and computer readable storage medium to record printer driver thereon

(76) Inventor: Sang-jin Park, Suwon-si (KR)

Correspondence Address: STANZIONE & KIM, LLP, 919 18TH STREET, N.W., SUITE 440, WASHINGTON, DC, 20006, US

(21) Appl. No.: 11/288,392

(22) Filed: Nov. 29, 2005

(30) Foreign Application Priority Data
Dec. 1, 2004 (KR) 2004-10003

(51) Int. Cl. G06F 3/12

(52) U.S. Cl. 358/1.13

(57) ABSTRACT

A method of generating print data in a printer driver includes selecting a predetermined print area on an image working space displayed on a monitor, requesting an operating system of a computer to provide image data corresponding to the selected print area, and converting the image data corresponding to the selected print area provided by the operating system into print data readable by a printer. Thus, in the print data generating method of the printer driver, a specific region on the image working space displayed on the monitor can be printed through the printer.

### CROSS-REFERENCE TO RELATED APPLICATIONS

This application claims the benefit under 35 U.S.C § 119 of Korean Patent Application No. 2004-100033, filed on Dec. 1, 2004, in the Korean Intellectual Property Office, the disclosure of which is incorporated herein in its entirety by reference.

### BACKGROUND OF THE INVENTION

1. Field of the Invention

The present general inventive concept relates to a print image generating method of a printer driver and a computer readable storage medium to record the printer driver thereon, and more particularly, to a print image generating method of a printer driver, in which only a specific area on an image working space displayed on a monitor is printed through a printer, and a computer readable storage medium to record the printer driver thereon.

2. Description of the Related Art

Generally, a computer and a printer constitute core and essential devices for office automation. To print a document prepared on the computer through the printer, the computer needs a printer driver to drive the printer. Most computer application programs have a print function to print through the printer driver.

The printer driver performs a function to transform data, such as documents prepared on an application program of the computer, into print data readable by the printer. When a command to print the data provided from the computer application program is received, the printer driver divides the data in units of a page, transforms the data into the print data readable by the printer by appropriately operating data or control codes included in the data by the quantity of one page, and provides the print data to the printer.

As computer and printer related technologies have been developed, there has been a tendency to add various functions to the printer driver. To meet needs from various users, the printer driver includes a function to process printouts.

Further, development in computer related technologies has enabled the computer to utilize various functions, for example, multimedia functions, searching for information in various fields using the Internet, exceeding utilization of simple operations, document preparation, etc.

This development of computer technologies has led to a desire to print various images provided from the computer through various methods. Accordingly, there is a need to develop various convenient printing methods.

### SUMMARY OF THE INVENTION

Accordingly, the present general inventive concept provides a print image generating method of a printer driver, in which only a specific region on an image working space displayed on a monitor is printed through a printer, and a computer readable storage medium to record the printer driver thereon.

Additional aspects of the present general inventive concept will be set forth in part in the description which follows and, in part, will be obvious from the description, or may be learned by practice of the present general inventive concept.

The foregoing and/or other aspects of the present general inventive concept may be achieved by providing a method of generating print data in a printer driver, the method comprising selecting a print area on an image working space displayed on a monitor, requesting an operating system of a computer to provide image data corresponding to the selected print area, and converting the provided image data corresponding to the selected print area into print data readable by a printer.

The selecting of the print area may comprise selecting any one of windows respectively having a frame area and a view area, displayed on the image working space, and setting the view area of the selected window to be the print area.

The selecting of the any one of the windows may comprise activating a graphic user interface provided by the printer driver on the image working space, selecting a first print function through the graphic user interface, and setting a highest one of the windows on the image working space to be the selected one of the windows according to the selection of the first print function.

The selecting of the print area may comprise activating the graphic user interface provided by the printer driver on the image working space, selecting a second print function through the graphic user interface, and selecting an area on the image working space using an input unit of the computer as the print area.

The requesting of the operating system of the computer to provide the image data corresponding to the selected print area may comprise detecting a position value of the print area on the image working space, and requesting the operating system to provide the image data corresponding to the detected position value.

The method may further comprise storing the image data corresponding to the selected print area.

The foregoing and/or other aspects of the present general inventive concept may also be achieved by providing a method of generating print data, the method comprising selecting a portion of a displayed image work space, detecting a position of the selected portion on the displayed image work space and retrieving image data corresponding to the detected position, and converting the retrieved image data into printable print data.

The foregoing and/or other aspects of the present general inventive concept may also be achieved by providing a storage medium readable by a computer recording thereon a printer driver to perform the method comprising selecting a predetermined print area on an image working space displayed on a monitor, requesting an operating system of a computer to provide image data corresponding to the selected print area, and converting the provided image data corresponding to the selected print area into print data readable by a printer.

The selecting of the print area may comprise selecting any one of windows respectively having a frame area and a view area, displayed on the image working space, and setting the view area of the selected window to be the print area.

The selecting of the print area may comprise activating a graphic user interface provided by the printer driver on the image working space, selecting a print function through the graphic user interface, and selecting an area on the image working space using an input unit of the computer as the print area.

The foregoing and/or other aspects of the present general inventive concept may also be achieved by providing a storage medium readable by a computer and having executable codes to perform a method of generating print data thereon, the method comprising selecting a portion of a displayed image work space, detecting a position of the selected portion on the displayed image work space and retrieving image data corresponding to the detected position, and converting the retrieved image data into printable print data.

The foregoing and/or other aspects of the present general inventive concept may also be achieved by providing a printer driver usable with a computer and a display to generate print data corresponding to an area of the display, the printer driver comprising a user interface module to select a print area of an image working space of the display, an image reading module to read out image data corresponding to the selected print area from the computer, and an image converting module to convert the read out image data into print data to be printed.

The foregoing and/or other aspects of the present general inventive concept may also be achieved by providing a host apparatus to communicate with a printer and to generate print data to be printed by the printer, the host apparatus comprising a display to display images on an image working space thereof, a selecting unit to select a print area on the image working space, a image data unit to detect a position of the selected area on the image working space and to supply image data corresponding to the detected position of the selected print area, a conversion unit to convert the supplied image data into print data to be printable by the printer.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a control block diagram illustrating a printing system according to an embodiment of the present general inventive concept;

FIG. 2 is a diagram illustrating a configuration of a printer driver according to an embodiment of the present general inventive concept;

FIG. 3 is a diagram illustrating an example of a graphic user interface provided by the printer driver of FIG. 2 according to an embodiment of the present general inventive concept; and

FIG. 4 is a control flow chart illustrating operations to generate print data in the printer driver of FIG. 2 according to an embodiment of the present general inventive concept.

FIG. 5 is a control flow chart illustrating operations to generate print data in the print driver of FIG. 2 according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept while referring to the figures.

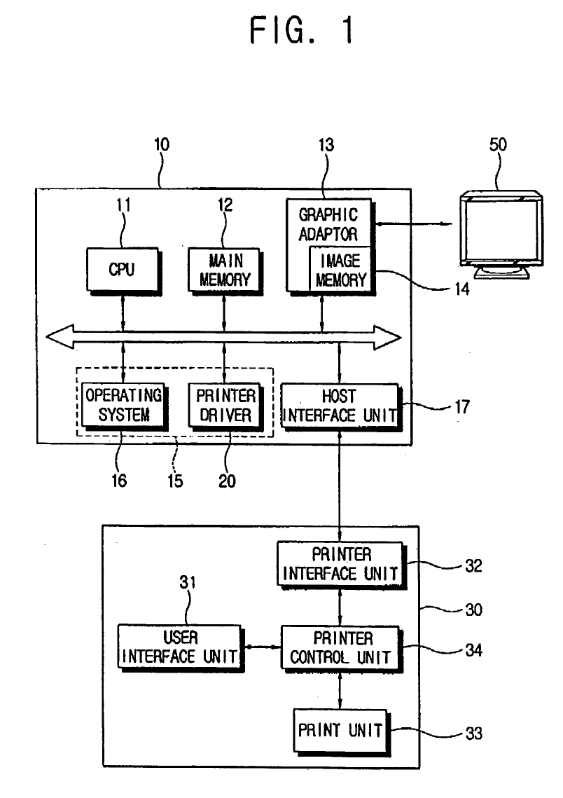

FIG. 1 is a control block diagram illustrating a printing system according to an embodiment of the present general inventive concept. Referring to FIG. 1, the printing system comprises a printer 30 to form print images on paper and a computer 10 to act as a host to output print data to be printed by the printer 30. The printing system may include a monitor 50 connected to the computer 10 to display image signals output from the computer 10 on a screen as display images.

The computer 10 may comprise a central processing unit (CPU) 11, a main memory 12, a graphic adaptor 13, and a hard disk drive 15 including an operating system 16 and a printer driver 20. Although the printer driver 20 is illustrated in FIG. 1 as being provided in the hard disk drive 15, the printer driver 20 may alternately be provided in other recording media than the hard disk drive 15.

The CPU 11 performs control and operation functions, and executes application programs stored in the hard disk drive 15 in association with the main memory 12. That is, the CPU 11 loads the application programs stored in the hard disk drive 15 to the main memory 12 and executes the application programs loaded into the main memory 12.

The main memory 12 stores the application programs to be executed by the CPU 11 and a variety of data therein temporarily. The main memory 12 may include a random access memory (RAM) in the form of a volatile memory which is readable and writable.

The graphic adaptor 13 outputs the image signals to the monitor 50. The graphic adaptor 13 may include an image memory 14 in which data relating to the image signals output to the monitor 50 is temporarily stored.

The operating system 16 stored in the hard disk drive 15 can include, for example, any one of WINDOWS™ series of Microsoft Corporation. The operating system 16 generates data to form an image working space and provides the generated data to the graphic adaptor 13 to display a background picture and windows activated by executing the application programs on the monitor 50. The graphic adaptor 13 transforms the generated data into the image signals which can be processed by the monitor 50 and supplies the image signals to the monitor 50 to display the image working space on the monitor 50.

The hard disk drive 15 stores the application programs therein, e.g., a word processing program, an image viewer program, a web browser for the Internet, etc. The application programs can be installed on the computer 10 so as to be operated in association with the operating system 16.

The printer driver 20 requests a graphic data processing function or a graphic device interface (GDI) function when the printer driver 20 senses that printing has been requested in one of the application programs. Here, the graphic data processing function can be provided by the operating system 16, analyzes font related data included in a document when requested by the printer driver 20, and provides the analysis result to the printer driver 20.

Furthermore, the printer driver 20 is supplied with font and graphic information included in the document from the graphic data processing function, generates a command to print the document, and transmits the generated command to the printer 30 through a host interface unit 17.

The host interface unit 17 may be connected with a printer interface unit 32, to be described later, of the printer 30, through a variety of communication methods. For example, the host interface unit 17 and the printer interface unit 32 can mutually communicate with each other through a parallel centronics interface, a serial interface, such as a universal serial bus (USB) interface, or a network, such as a local area network (LAN).

The printer 30 according to the present embodiment may include the printer interface unit 32, a print unit 33, a user interface unit 31, and a printer control unit 34. The user interface unit 31 may include a manipulation panel formed with a plurality of buttons, and a display panel, such as an LCD, mounted on the manipulation panel.

The print unit 33 prints an image corresponding to the print data received from the computer 10 through the print interface unit 32 on the paper according to the control of the printer control unit 34. The print unit 33 may print the image on the paper through an inkjet mechanism, an electrophotographic mechanism, or the like.

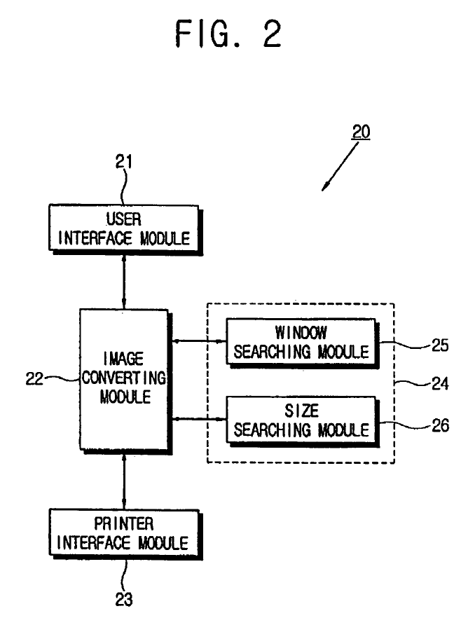

FIG. 2 illustrates the printer driver 20 of the computer 10 of FIG. 1 according to an embodiment of the present general inventive concept.

Referring to FIGS. 1-2, the printer driver 20 may comprise a user interface module 21, a window searching module 25, a size searching module 26, an image converting module 22 and a printer interfacing module 23.

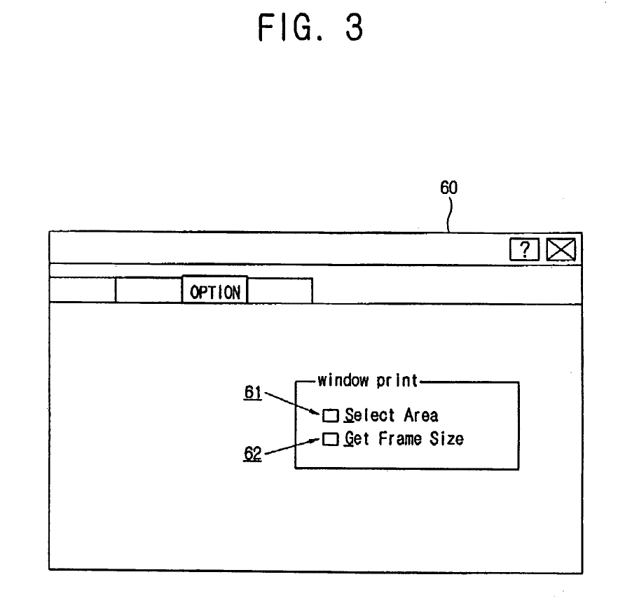

The user interface module 21 displays a graphic user interface 60 (see FIG. 3) on the monitor 50 to set/select various functions supplied by the printer driver 20 to control the printer 30 when a user requests execution of the printer driver 20 through an input unit of the computer 10, for example, a keyboard or a mouse.

FIG. 3 is a diagram illustrating an example of the graphic user interface 60 displayed on the monitor 50 to print a selected area according to an embodiment of the present general inventive concept. Referring to FIG. 3, the graphic user interface 60 can be provided with a first check box 61 to select a ‘Select area’ print function, and a second check box 62 to select a ‘GetFrameSize’ print function. The ‘Select area’ print function allows the user to select an area of the image working space to be printed. The ‘GetFrameSize’ print function allows the user to print a view area of a window displayed on the image working space. The ‘Select area’ print function and the ‘GetFrameSize’ print function will be described in greater detail below.

The printer driver 20 may comprise an image reading module 24 to request the operating system 16 to provide image data corresponding to the selected printing function, where the user selects one of the ‘Select Area’ printing function and the ‘GetFrameSize’ printing function.

The image data reading module 24 may comprise the size searching module 26 to search for image data corresponding to the ‘Select Area’ print function, and the window searching module 25 to search for image data corresponding to the ‘GetFrameSize’ print function. Operations of the size searching module 26 and the window searching module 25 to retrieve the image data corresponding to respective printing functions from the operating system 16 will be described in greater detail below.

The image converting module 22 converts the image data provided from the image data reading module 24 or image data provided from an application program into the print data readable by the printer 30. The image converting module 22 may convert the image data into the print data using one of a printer command language (PCL) and a post script (PS) language of the printer 30.

The printer interfacing module 23 allows the printer 30 to perform a print job by transmitting the print data converted by the image converting module 22 to the printer 30 through the host interface unit 17 of the computer 10.

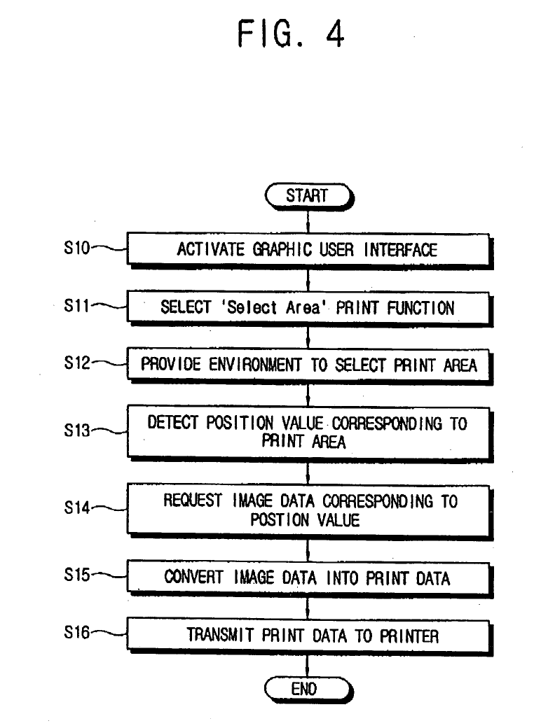

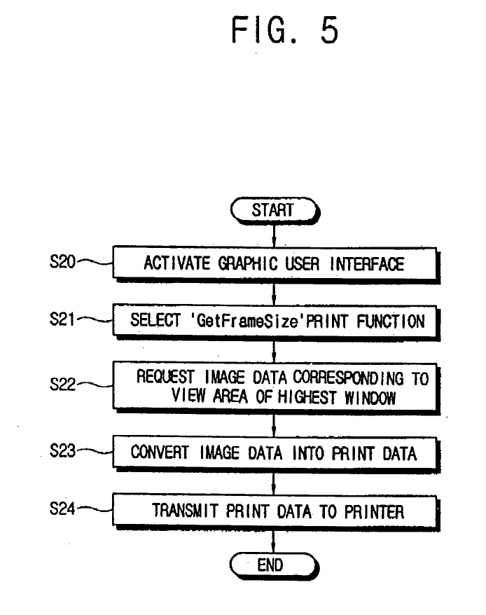

Operations of the printer driver 20 to control the printer 30 to print a print area selected by the user on the image working space will be described below with reference to FIGS. 4 and 5.

FIG. 4 illustrates a method of generating print data in the printer driver 20 according to an embodiment of the present general inventive concept. In the embodiment of FIG. 4, the ‘Select Area’ print function provided by the printer driver 20 will be described in greater detail.

Referring to FIG. 4, a user activates the graphic user interface 60 provided by the printer driver 20 using a mouse, a keyboard, or the like of the computer 10 at operation S10. The user interface module 21 of the printer driver 20 recognizes the activation of the graphic user interface 60 and displays the graphic user interface 60 on the monitor 50. The user interface module 21 operates in association with the operating system 16 so as to allow the graphic user interface 60 to be displayed on the monitor 50, and the graphic user interface 60 is displayed on the monitor 50 by driving the CPU 11, the main memory 12, and the graphic adaptor 13 of the computer 10.

The user then selects the ‘Select Area’ print function using the graphic user interface 60, as illustrated in FIG. 3, at operation S11. Accordingly, the user interface module 21 informs the size searching module 26 of the image data reading module 24 that the ‘Select Area’ print function is selected by the user.

When it is sensed that the ‘Select Area’ print function is selected, the size searching module 26 provides an environment to allow the user to select a print area to be printed on the image working space displayed on the monitor 50 at operation S12. For example, before the user selects the ‘Select Area’ print function, the graphic user interface 60 can be displayed as the highest window on the image working space displayed on the monitor 50, and when it is sensed that the ‘Select Area’ print function is selected, the graphic user interface 60 is no longer displayed on the image working space as the highest window. For example, a window corresponding to the ‘Select Area’ print function may be the highest window to be display over the other windows.

The user then selects a print area to be printed using the input unit of the computer 10 on the image working space in which the graphic user interface 60 may be removed of hidden by other windows. For example, the user can select the print area by dragging a point of the mouse while clicking a left button of the mouse after positioning the mouse point on a specific point of the image working space. The user interface module 21 of the printer driver 20 then detects a position value on the image working space corresponding to the print area selected through the input unit at operation S13.

The size searching module 26 requests the operating system 16 to provide image data corresponding to the position value detected by the user interface module 21 at operation S14. That is, the size searching module 26 provides the operating system 16 with the detected position value and the operating system 16 reads out data corresponding to the detected position value provided by the size searching module 26 from data to display the image working space. The operating system 16 provides the read out data to the size searching module 26. The operating system 16 may read out the image data corresponding to the detected position value from data stored in the image memory 14 provided in the graphic adaptor 13.

The size searching module 26 supplies the image data provided from the operating system 16 to the image converting module 22. The image converting module 22 converts the image data supplied from the size searching module 26 into the print data of a format to be processed by the printer 30 at operation S15. The printer interface module 23 then transmits the print data generated by the image converting module 22 to the printer 30 through the host interface unit 17 of the computer 10 at operation S16.

Accordingly, the printer 30 can print the print area selected by the user on the image working space on paper.

FIG. 5 illustrates a method of generating print data in the printer driver 20 according to another embodiment of the present general inventive concept. In the embodiment of FIG. 5, the ‘GetFrameSize’ print function provided by the printer driver 20 will be described in greater detail. A user activates the graphic user interface 60 at operation S20. Since operation S20 of FIG. 5 is similar to operation S10 of FIG. 4, a detailed description thereof will be omitted.

The user then selects the ‘GetFrameSize’ print function using the graphic user interface 60 as illustrated in FIG. 3 at operation S21. Accordingly, the user interface module 21 informs the window searching module 25 of the image data reading module 24 that the ‘GetFrameSize’ print function is selected by the user.

When it is sensed that the ‘GetFrameSize’ print function is selected, the window searching module 25 requests the operating system 16 of the computer 10 to provide image data corresponding to a view area of the highest window among the windows displayed on the image working space at operation S22. In other words, the ‘GetFrameSize’ print function according to the present embodiment sets a print area to be to the view area of the highest window on the image working space. The view area of the highest window includes an area of the highest window that is viewable within a frame of the highest window. The operating system 16 provides the image data corresponding to the view area of the highest window to the window searching module 25.

The image data corresponding to the view area of the highest window provided from the operating system 16 through the window searching module 25 is converted by the image converting module 22 into print data having a format to be processed by the printer 30 at operation S23.

The print data converted by the image converting module 22 is then transmitted to the printer 30 through the printer interface module 23 at operation S24. Here, the printer interface module 23 transmits the print data to the printer 30 through the host interface unit 17.

Accordingly, the printer 30 can print the view area of the highest window on the image working space on paper as selected by the user.

As illustrated in FIG. 5, the printer driver 20 can set the print area to be the view area of the highest window. Alternatively, the printer deriver 20 can provide an environment in which a user can select any one of the windows displayed on the image working space when the user selects the ‘GetFrameSize’ print function. For example, the graphic user interface 60 displayed on the image working space can be removed from the image working space, and the user can select one of the windows displayed on the image working space. The window selected by the user among the windows displayed on the image working space can then be recognized as the highest window. Accordingly, although a window desired to be printed may not be displayed as the highest window in the image working space when the ‘GetFrameSize’ print function is selected, the user may select the desired window to print the view frame of the desired window.

When the user selects one of the ‘SelectArea’ function and the ‘GetFrameSize’ function through the graphic user interface 60, the printer driver 20 may store the image data read out by the provided by the operating system 16 in a format of a predetermined file, for example, an image file format. Accordingly, the user can read out the stored file and perform an additional print job.

By selecting a print area on an image working space displayed on the monitor 50, requesting the operating system 16 of the computer 10 to provide image data corresponding to the selected print area, converting the image data corresponding to the selected print area as provided by the operating system 16 into print data readable by the printer 30 and outputting the print data to the printer 30, specific areas on the image working space displayed on the monitor 50, such as the whole of plural windows or a part of each window or a view area of the window represented by a part of an application program or plural application programs, can be printed according to a selection of the user, instead of being printed by units of a page in an application program.

As described above, according to the embodiments of the present general inventive concept, there is provided a print data generating method of a printer driver, in which only a specific area on an image working space displayed on a monitor is printed through a printer, and a computer readable storage medium recording the printer driver thereon.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of generating print data of a printer driver, comprising:
selecting a print area on an image working space displayed on a monitor;
requesting an operating system of a computer to provide image data corresponding to the selected print area; and
converting the image data corresponding to the selected print area as provided by the operating system into the print data readable by a printer.

2. The method according to claim 1, wherein the selecting of the print area comprises:
selecting one of windows displayed on the image working space and respectively having a frame area and a view area; and
setting the view area of the selected window to be the print area.

3. The method according to claim 2, wherein the selecting of the one of the windows comprises:
activating a graphic user interface provided by the printer driver on the image working space;
selecting a predetermined print function through the graphic user interface; and
setting a highest window on the image working space to the selected window according to selection of the first print function.

4. The method according to claim 2, further comprising:
storing the image data corresponding to the selected print area.

5. The method according to claim 1, wherein the selecting of the print area comprises:
activating a graphic user interface provided by the printer driver on the image working space;
selecting a predetermined print function through the graphic user interface; and
selecting an area on the image working space using an input unit of the computer and setting the selected area to be the print area.

6. The method according to claim 5, wherein the requesting of the operating system of a computer to provide the image data corresponding to the selected print area comprises:
detecting a position value of the print area on the image working space; and
requesting the operating system to provide the image data corresponding to the detected position value.

7. The method according to claim 5, further comprising:
storing the image data corresponding to the selected print area.

8. The method according to claim 1, further comprising:
transmitting the print data to the printer.

9. A storage medium readable by a computer to record a printer driver to perform a method of generating print data thereon, the method comprising:
selecting a predetermined print area on an image working space displayed on a monitor;
requesting an operating system of a computer to provide image data corresponding to the selected print area; and
converting the image data corresponding to the selected print area as provided by the operating system into print data readable by the printer.

10. The storage medium according to claim 9, wherein the selecting of the print area comprises:
selecting one of windows displayed on the image working space and respectively having a frame area and a view area; and
setting the view area of the selected window to be the print area.

11. The storage medium according to claim 9, wherein the selecting of the print area comprises:
activating a graphic user interface provided by the printer driver on the image working space;
selecting a predetermined print function through the graphic user interface; and
selecting an area on the image working space using an input unit of the computer, and setting the selected area to be the print area.

12. A printer driver usable with a computer and a display to generate print data corresponding to an area of the display, the printer driver comprising:
a user interface module to provide an environment so that a position value corresponding to a print area of an image working space of the display is selected;
an image reading module to read out image data corresponding to the position value of the selected print area from the computer; and
an image converting module to convert the read out image data into print data to be printed.

13. The printer driver according to claim 12, wherein the user interface module displays a graphic user interface on the image working space of the display to select one of a first and second type of print area.

14. The printer driver according to claim 13, wherein the graphic user interface selects the first type of print area, the user interface module selects a portion of an image displayed on the image working space as the print area, and when graphic user interface selects the second type of print area, the user interface module selects a viewable area of one of one or more windows displayed on the image working space as the print area.

15. The printer driver according to claim 14, wherein the image reading module comprises:
a first searching module to retrieve the image data corresponding to the selected portion of the image displayed on the working space when the graphic user interface selects the first type of pint area; and
a second searching module to retrieve the image data corresponding to the viewable area of the one of the one or more windows displayed on the image working space when the graphic user interface selects the second type of print area.

16. The printer driver according to claim 14, wherein when the graphic user interface selects the second type of print area, the user interface module selects the viewable area of highest one of the one or more windows displayed on the image working space as the print area.

17. The printer driver according to claim 12, further comprising:
a printer interface module to transmit the print data to an external printer.

18. A host apparatus to communicate with a printer and to generate print data to be printed by the printer, the host apparatus comprising:
a display to display images on an image working space thereof;
a selecting unit to select a print area on the image working space;
a image data unit to detect a position of the selected area on the image working space and to supply image data corresponding to the detected position of the selected print area; and
a conversion unit to convert the supplied image data into print data to be printable by the printer.

19. The host apparatus according to claim 18, further comprising:
a storage unit to store data corresponding to the images displayed on the image working space, wherein the image data unit reads out the image data corresponding to the detected position of the selected print area from the data stored in the storage unit.

20. The host apparatus according to claim 18, wherein the selected print area comprises a portion of one of the images displayed on t eh image working space.

21. The host apparatus according to claim 18, wherein the display displays one or more windows on the image working space and the selected print area comprises a viewable area of one of the displayed windows.

22. The host apparatus according to claim 18, further comprising:
a interface unit to communicate with the printer to transmit the print data to the printer.
